(19) United States
(12) Patent Application Publication
(10) Pub. No.: US 2018/0213826 A1
(43) Pub. Date: Aug. 2, 2018

(54) FERMENTATION DEVICES AND METHODS TO USE THE SAME

(71) Applicant: Taylor Precision Products, Inc., Seattle, WA (US)

(72) Inventor: Leif Erickson, Seattle, WA (US)

(21) Appl. No.: 15/883,445

(22) Filed: Jan. 30, 2018

Related U.S. Application Data
(60) Provisional application No. 62/452,157, filed on Jan. 30, 2017.

(51) Int. Cl. A23L 3/00; A23L 3/3589; B65D 51/16; B65D 1/10; B65D 81/22

(52) U.S. Cl. CPC A23L 3/001; A23L 3/3589; A23B 7/10; B65D 1/10; B65D 81/22; B65D 51/1611

(57) ABSTRACT

A fermentation device that ferments a wide variety of food products can include a fermentation vessel and a fermentation lid assembly which is removably coupleable to the fermentation vessel. The fermentation lid assembly can include a lid body having a chamber that is sized and shaped to receive a barrier fluid, the lid body having an aperture that fluidly couples the lid body to the fermentation vessel, a lid cap positioned to overlie the aperture, and a lid that covers the chamber. The lid can have a plurality of vent holes that are sized and shaped to provide a fluid flow path from the fermentation vessel to an exterior of the fermentation device via the aperture of the lid body. Related methods are also provided.

### BACKGROUND

### Technical Field

The present disclosure is generally related to fermentation devices.

### Description of the Related Art

Fermentation is generally a metabolic process that converts sugars into acids, gases, or alcohol. When fermentation is applied to certain food products, such as fruits, vegetables, and other food products, such as sauerkraut, kimchi, etc. (hereinafter “food products”), it generally involves lacto-fermentation, where bacterial organisms, i.e., Lactobacillus, can convert lactose and other sugars present in the food products into lactic acid. Such an acidic environment facilitates preservation of the food products and also provides a certain flavor to the food products.

During the fermentation process, gaseous fluids, such as carbon dioxide are produced due to a chemical reaction with the food product and a fermenting liquid that contacts the food product, such as brine. In order to prevent oxidation from occurring due to entrance of air into a fermentation vessel that contains the food products and also to prevent relatively high pressure build-up in the fermentation vessel caused by the carbon dioxide, it is important to allow the carbon dioxide to escape while preventing air from entering the fermentation vessel. Typical solutions have included providing airlock devices that are partially filled with water, which allows gases inside the fermentation vessel to escape as bubbles. Such airlock devices generally protrude outside the pressure vessel, and therefore compromise compactness of a fermentation device and are generally unsightly. For example, some airlock devices have an s-shaped structure with a cork disposed at one end, which end couples to the fermentation vessel. Another example of airlock devices comprises an elongated tube that couples to a cork coupled to the fermentation vessel. Such airlock devices, however, lack aesthetic appeal and compromise compactness of the fermentation device. For instance, airlock devices that protrude outwardly make such devices expansive and having a large footprint.

### BRIEF SUMMARY

The present disclosure describes various implementations of fermentation devices and related methods with robust, compact, and efficient form factors that enable fermentation of a wide variety of food products. In some implementations, a fermentation device can be summarized as including a fermentation vessel and a fermentation lid assembly removably coupleable to the fermentation vessel. The fermentation lid assembly can include a lid body having a chamber that is sized and shaped to receive a barrier fluid, the lid body having an aperture that fluidly couples the lid body to the fermentation vessel; a lid cap positioned to overlie the aperture; and a lid that covers the chamber. The lid can have a plurality of vent holes that are sized and shaped to provide a fluid flow path from the fermentation vessel to an exterior of the fermentation device via the aperture of the lid body.

In some implementations, a method for fermenting a food product disposed in a fermentation vessel can be summarized as including coupling the fermentation vessel to a fermentation lid assembly, the fermentation lid assembly including a lid and a lid body having a chamber; removing the lid for exposing the chamber; filling the chamber with barrier fluid to a desired level; and covering the chamber with the lid.

### BRIEF DESCRIPTION OF THE SEVERAL VIEWS OF THE DRAWINGS

FIG. 1 is a perspective view of a fermentation device, according to one example, non-limiting implementation.

FIG. 2 is an exploded view of the fermentation device of FIG. 1.

FIG. 3 is a cross-sectional view of the fermentation device of FIG. 1, taken along a central plane of the fermentation device, with certain components removed for clarity of description and illustration.

FIG. 4 is a perspective view of the fermentation device of FIG. 1, illustrating a partial cutaway view of the fermentation device, with certain components removed for clarity of description and illustration.

### DETAILED DESCRIPTION

In the following description, certain specific details are set forth in order to provide a thorough understanding of various disclosed implementations. One skilled in the relevant art will recognize that implementations may be practiced without one or more of these specific details. In other instances, well-known structures and devices associated with fermentation devices, and related apparatuses, systems, and methods may not be shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

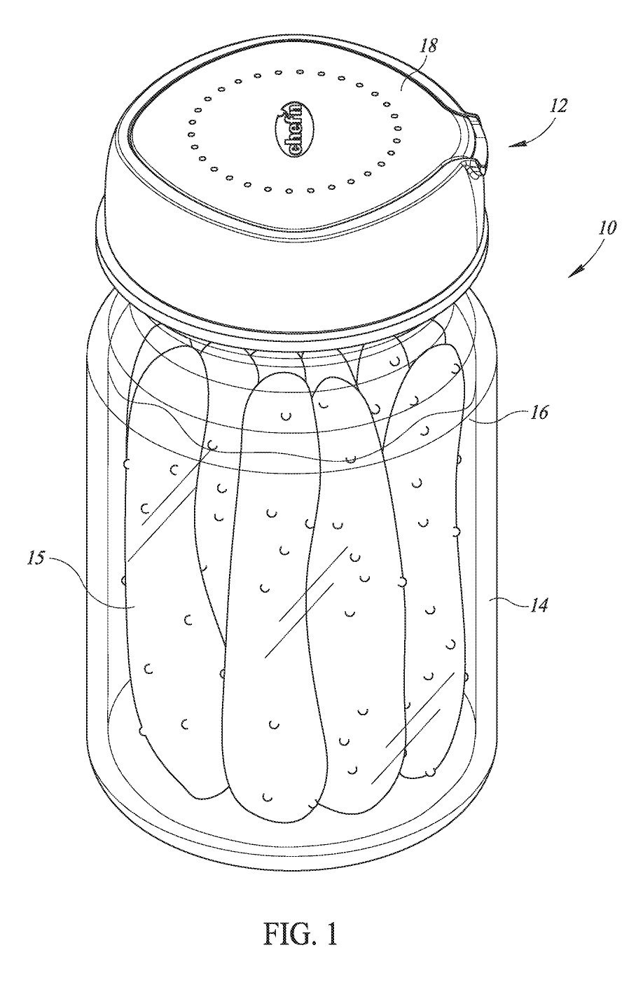

FIGS. 1 through 4 illustrate a fermentation device 10, according to one example, non-limiting implementation. The fermentation device 10 includes a fermentation lid assembly 12 and a fermentation vessel 14. As illustrated in FIG. 1, the fermentation vessel 14 is generally sized and shaped to receive one or more food products 15 and/or a fermentation fluid 16. The one or more food products 15 can include a wide variety of fruits, vegetables, and other consumable food items, such as, for example, carrots, cucumbers, sauerkraut, kimchi, etc. The fermentation fluid 16 can include any suitable liquid that can facilitate fermentation of the food products 15 by, for example, initially removing harmful bacterial from the food products 15 and providing an environment in which beneficial bacteria can be produced, such as, for example, Lactobacillus, which can convert sugars into lactic acid. In some implementations, the fermentation fluid 16 can include water and salt, e.g., brine. In some implementations, the fermentation fluid 16 can include water without salt. In some implementations, the fermentation fluid 16 can include one or more of water, salt, starter culture, such as whey, and/or fermentation inoculant, or any combination thereof.

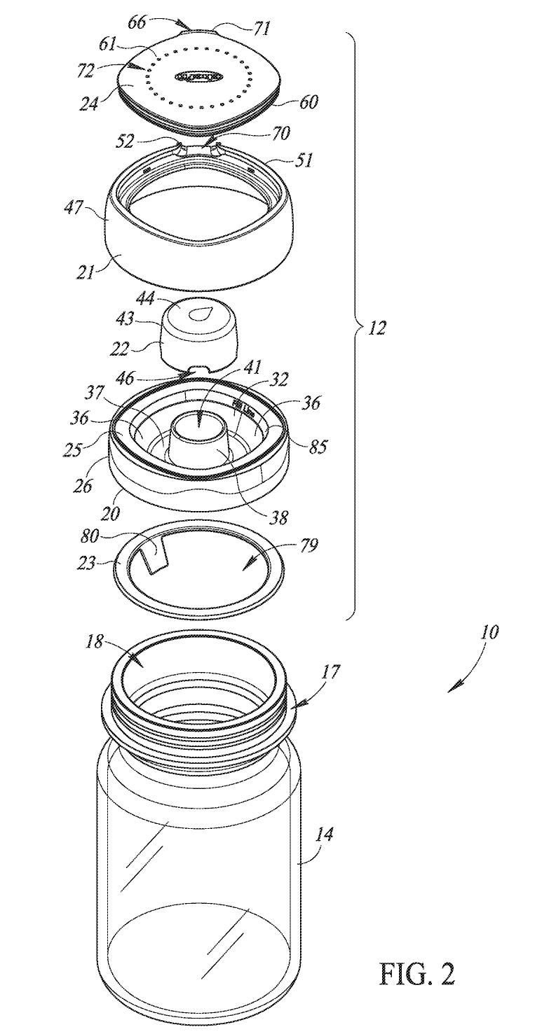

The fermentation vessel 14 is removably coupleable to the fermentation lid assembly 12. For example, in some implementations, as illustrated in FIGS. 1 through 2, the fermentation vessel 14 can include a plurality of threads 17 located proximal to an opening 18 of the fermentation vessel 14 through which food products 15 and the fermentation fluid 16 can be received in the fermentation vessel 14. The threads 17 of the fermentation vessel 14 can be sized and shaped to threadedly couple to the fermentation lid assembly 12. In other implementations, the fermentation vessel 14 and/or the fermentation lid assembly 12 can be removably coupleable to each other via a detent mechanism, such as a tab, tongue, or ball disposed on the fermentation vessel 14, which can engage with a lip, flange, or cavity disposed in the fermentation lid assembly 12, or vice versa. While FIG. 1 illustrates one example implementation of the fermentation vessel 14, in other implementations, the fermentation vessel 14 can take a wide variety of alternative shapes and/or forms.

The fermentation lid assembly 12 includes a lid body 20, a lid cover 21, a lid cap 22, a gasket 23, and a lid 24. The lid body 20, the lid cover 21, the lid cap 22, and the lid 24 can each comprise metals, plastics, or any combination thereof. In some implementations, one or more of the lid body 20, the lid cover 21, the lid cap 22, and the lid 24 can comprise materials that produce inherently resilient components. In some implementations, one or more of the lid body 20, the lid cover 21, the lid cap 22, and the lid 24 can be formed via a machining process, molding process (e.g., injection molding process, compression molding process, etc.), etc. The gasket 23 can comprise silicone, rubber, or any polymer, such as an elastomer. Again, the gasket 23 can be formed via any suitable process, such as molding, machining, etc.

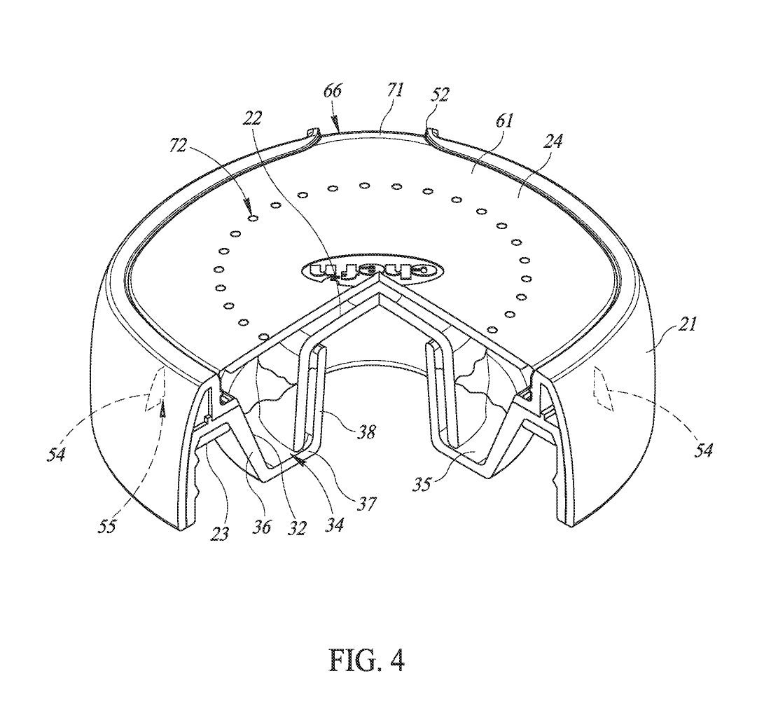

With reference to FIGS. 2 through 4 where the fermentation vessel 14 has been removed for clarity of illustration and description, the lid body 20 includes a base portion 25 and a wall portion 26 that extends circumferentially around the base portion 25. As illustrated in FIG. 1, the wall portion 26 is sized and shaped to surround a flange or an upper portion of the fermentation vessel 14, which includes the threads 17, when the fermentation vessel 14 is coupled to the fermentation lid assembly 12. For example, as discussed above, in some implementations, an interior surface 27 of the wall portion 26 can include one or more threads 28 that are sized and shaped to couple to the threads 17 of the fermentation vessel 14. The base portion 25 includes a ring portion 29 that extends radially around the lid body 20 and extends transversely to the wall portion 26. At an upper surface 30, the ring portion 29 includes a lip 31 that protrudes outwardly from the upper surface 30 and radially extends around the ring portion 29. The base portion 25 includes a container portion 32 which extends inwardly from an end of the ring portion 29 toward a central axis 33 of the fermentation lid assembly 12. The container portion 32 is sized and shaped to define a chamber 34 which can hold a barrier fluid 35, such as water. For example, FIG. 4 illustrates a partial cutaway view of the fermentation lid assembly 12 with the barrier fluid 35 disposed in the container portion 32. More generally, during fermentation, a pressure differential is generated between an inside of the fermentation device 10 and an exterior of the fermentation device 10. For example, production of carbon dioxide during fermentation causes a higher pressure in the fermentation device 10 relative to the ambient pressure. The barrier fluid 35 disposed in the container portion 32 creates a sealed pressure barrier, which allows carbon dioxide to escape the fermentation device 10 while restricting or limiting air from entering the fermentation device 10, in particular the fermentation vessel 14, and causing oxidation to occur.

As illustrated in FIGS. 2 through 4, the container portion 32 has a generally frusto-conical shape with a chamber wall portion 36 that is oriented angularly with respect to the central axis 33 and circumferentially extends around the base portion 25. The chamber wall portion 36 extends to a chamber base portion 37 that extends transversely toward the central axis 33 from an end of the chamber wall portion 36. A chamber flange portion 38 protrudes outwardly from an edge of the chamber base portion 37. In this manner, an inner surface 39 of the chamber wall portion 36 and an outer surface 40 of the chamber flange portion 38, with the chamber base portion 37 therebetween, define the chamber 34 which can hold the barrier fluid 35. The chamber flange portion 38 is angularly oriented relative to the central axis 33 of the fermentation lid assembly 12 and includes an aperture 41 that extends through the chamber flange portion 38 to define a generally hollow structure. As discussed in more detail below, the aperture 41 is generally sized and shaped to allow carbon dioxide to escape from the fermentation vessel 14 during fermentation.

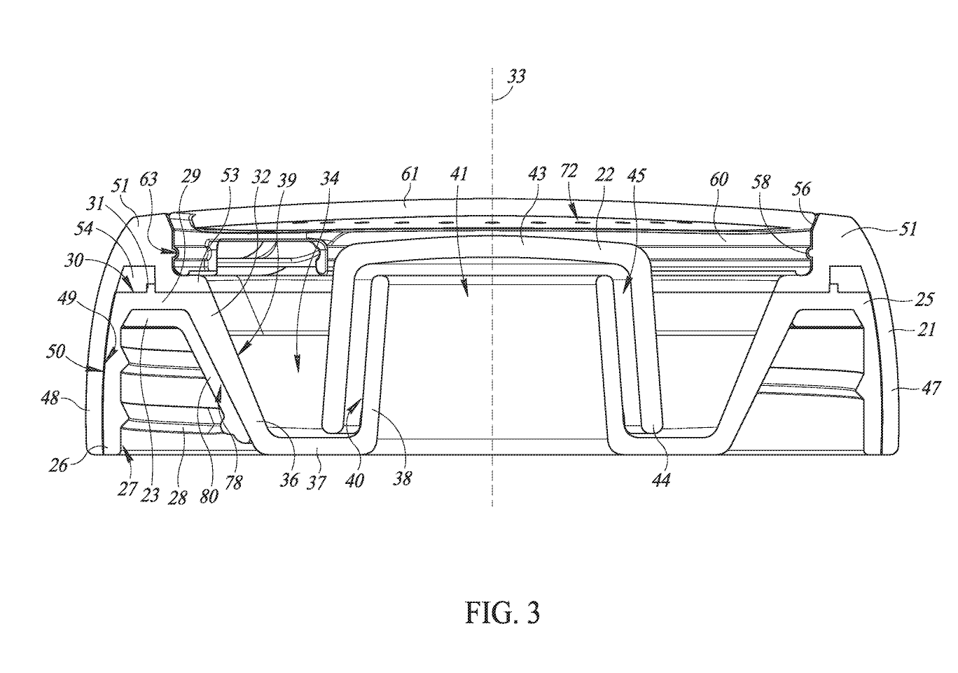

The lid cap 22 is generally sized and shaped to be received in the chamber 34 and overlie the aperture 41 of the chamber flange portion 38. The lid cap 22 includes a cap base portion 43 and a cap wall portion 44 that extends from the cap base portion 43 and circumferentially surrounds the cap base portion 43. The cap wall portion 44 is angularly oriented relative to the central axis 33 of the fermentation lid assembly 12. In some implementations, the angular orientation of the cap wall portion 44 relative to the central axis 33 of the fermentation lid assembly 12 orients the cap wall portion 44 to be substantially parallel to, and spaced apart, from the chamber flange portion 38 to define a passageway 45. The passageway 45 is sized and shaped to allow the carbon dioxide to move or escape from the fermentation vessel 14 into the chamber 34. For example, as illustrated in FIG. 3, the cap wall portion 44 has an axial length which is larger than an axial length of the chamber flange portion 38. Further, circumferential lengths of the cap wall portion 44 are larger than circumferential lengths of the chamber flange portion 38. In this manner, as the lid cap 22 is positioned to overlie the chamber wall portion 38, the cap wall portion 44 is spaced apart from the chamber flange portion 38 to define the passageway 45. The lid cap 22 includes one or more recesses 46 disposed in the cap wall portion 44. The one or more recesses 46 are angularly spaced apart relative the central axis 33 of the fermentation lid assembly 12 and are sized and shaped to allow the carbon dioxide received in the passageway 45 to move or escape to the chamber 34.

The lid cover 21 is generally sized and shaped to surround the lid body 20 and be coupled thereto. In some implementations, the lid cover 21 can be coupled to the lid body 20 via welding, fastening, or adhering. In other implementations, the lid cover 21 and the lid body 20 can be integrally formed as a monolithic unit. The lid cover 21 includes a cover wall 47 which extends circumferentially around the lid cover 21. The cover wall 47 includes a lower wall portion 48 having a cover interior surface 49 that contacts or mates with a cover outer surface 50 of the wall portion 26 of the lid body 20. The cover wall 47 also includes an upper wall portion 51 which includes a spout element 52 that protrudes outwardly relative to the central axis 33 of the fermentation lid assembly 12. The spout element 52 is generally sized and shaped to provide a fluid passageway 70 which can allow the barrier fluid 35 disposed in the chamber 34 to be removed or expelled to achieve a desirable level. For example, under certain conditions, the chamber 34 may include excess barrier fluid 35. In such conditions, a user can expel excess volume of barrier fluid 35 from the chamber 34 via the spout element 52. The upper wall portion 51 also includes a transverse cover portion 53 that extends transversely toward the central axis 33 of the fermentation lid assembly 12.

The lid cover 21 includes a plurality of cover tab elements 54 that are radially spaced apart relative to the central axis 33 of the fermentation lid assembly 12. The cover tab elements 54 are disposed between the cover interior surface 49 of the lower wall portion 48 and the transverse cover portion 53. The cover tab elements 54 include a coupling recess 55 that is sized and shaped to receive the lip 31 of the lid body 20, as the lid cover 21 is coupled to the lid body 20. A wall portion interior surface 56 of the upper wall portion 51 includes a plurality of tab elements 58 that are radially spaced apart relative to the central axis 33 of the fermentation lid assembly 12. Each tab element 58 is sized and shaped to removably coupleably receive the lid 24.

In particular, the lid 24 includes a lid wall portion 60 that extends circumferentially around the lid 24 and a lid base portion 61 that extends transversely from the lid wall portion 60. The lid base portion 61 includes a lid recess 63 which is sized and shaped to be removably coupleably received by the tab elements 58 of the lid cover 21. For example, the lid wall portion 60 can be configured to be resilient such that when the lid 24 is coupled to the lid cover 21, the lid wall portion 60 can elastically deform such that the tab elements 58 are received by the lid recess 63 and provide sufficient frictional forces to removably couple the lid 24 to the lid cover 21. The lid wall portion 60 also includes a fluid opening 66 that is sized and shaped to substantially align with the spout element 52 in the upper wall portion 51 of the lid cover 21. In this manner, the barrier fluid 35 can be expelled from the chamber 34 via the fluid opening 66 of the lid 24 and the fluid passageway 70 of the lid cover 21 into an exterior of the fermentation device 10.

As illustrated in FIG. 4, the lid base portion 61 includes lid tab element 71 which is positioned to overlie the fluid opening 66. Thus, when the lid 24 is coupled to the lid cover 21, the lid tab element 71 extends into the spout element 52. In this manner, the lid tab element 71 provides access and gripping ability to a user to remove the lid 24 when desired. The lid base portion 61 includes a plurality of vent holes 72. The vent holes 72 are radially spaced apart relative to the central axis 33 of the fermentation lid assembly 12. The vent holes 72 are sized and shaped to allow carbon dioxide generated during fermentation to escape from the chamber 34 into the environment. Thus, as illustrated in FIGS. 1 through 4, the fermentation device 10 provides a plurality of venting locations for the carbon dioxide to escape to the environment in the forms of the plurality of vent holes 72 and the fluid passageway 70 disposed in the spout element 52 of the lid cover 21.

With continued reference to FIGS. 1 through 4, the fermentation device 10 is configured to sealingly couple the fermentation vessel 14 to the fermentation lid assembly 12. In particular, the gasket 23 of the fermentation lid assembly 12 is sized and shaped to be disposed between the lid body 20 and the fermentation vessel 14. The gasket 23 includes a gasket aperture 79 that is sized and shaped to surround the container portion 32 of the lid body 20. As illustrated in FIG. 3, the gasket 23 is positioned in a gap defined between the interior surface 27 of the wall portion 26 and an exterior surface 78 of the container portion 32. The gasket 23 is sized and shaped to fit in the gap such that sufficient frictional forces can tautly couple the gasket 23 to the lid body 20.

In some implementations, as illustrated in FIGS. 2 and 3, the gasket 23 includes a gasket tab element 80 that mates with the exterior surface 78 of the container portion 32. The gasket tab element 80 provides gripping ability to a user so that the gasket 23 can be removably coupled to the lid body 20. Thus, a user can remove the gasket 23 for cleaning purposes and re-couple the gasket 23 to the lid body 20.

Thus, in operation, a user can dispose food products 15 in the fermentation vessel 14 via the opening 18. The fermentation vessel 14 can be filled with the fermentation fluid 16. The fermentation lid assembly 12 can thereafter be coupled to the fermentation vessel 14. In contrast to conventional airlock devices that protrude from a fermentation vessel, the fermentation lid assembly 12 provides robust and compact form factors. For example, the chamber 34, the lid cap 22, the gasket 23, etc. are disposed internally with the lid 24 covering or overlying the components of the fermentation lid assembly 12 by being removably coupleable to the lid cover 21. In this manner, the fermentation lid assembly 12 improves compactness and avoids unsightly expansive devices, such as those that protrude outwardly from a fermentation vessel.

As described above, the fermentation lid assembly 12 can be coupled to the fermentation vessel 14 via threads 28 of the lid body 20 that can engage with and couple to the threads 17 of the fermentation vessel 14. Again, the gasket 23 disposed between the lid body 20 and the fermentation vessel 14 can provide a sealing engagement between the fermentation lid assembly 12 and the fermentation vessel 14.

The lid 24 can be removed from the lid cover 21 via the lid tab element 71 to provide access to the chamber 34 of the lid body 20. The user can thereafter fill the chamber 34 with the barrier fluid 35 to a desirable level. In some implementations, the container portion 32 can include markings 85 (FIG. 2) which can specify a desirable barrier fluid 35 level. If any excess barrier fluid 35 has to be expelled, such can be achieved by expelling the barrier fluid 35 via the spout element 52 of the lid cover 21.

The lid 24 can be coupled to the lid cover 21 to initiate fermentation of the food products 15 with the barrier fluid 35 disposed in the chamber 34 providing the pressure barrier. As the food products 15 undergo fermentation, the carbon dioxide produced can flow through the aperture 41 of the chamber flange portion 38 into the passageway 45 between the lid cap 22 and the chamber wall portion 38 of the lid body 20, so the carbon dioxide is received in the chamber 34. As discussed above, the barrier fluid 35 provides a pressure barrier which allows the carbon dioxide to escape to the environment through the vent holes 72 and/or the fluid passageway 70 of the lid cover 21 while restricting air or oxygen to flow into the fermentation vessel 14. Thus, in this manner, the high pressure, for example, built inside the fermentation vessel 14 during fermentation can be relieved while restricting oxidation. Upon reaching a desired level of fermentation, the barrier fluid 35 can be expelled via the spout element 52 of the lid cover 21 and the fermentation lid assembly 12 can be removed from the fermentation vessel 14 to access the food products 15.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A fermentation device, comprising:
a fermentation vessel; and
a fermentation lid assembly removably coupleable to the fermentation vessel, the fermentation lid assembly including:
a lid body having a chamber that is sized and shaped to receive a barrier fluid which allows flow of gaseous fluid from the fermentation vessel to an exterior of the fermentation device while restricting flow of air from the exterior into the fermentation vessel, the lid body having an aperture that fluidly couples the lid body to the fermentation vessel;
a lid cap positioned to overlie the aperture; and
a lid that covers the chamber, the lid having a plurality of vent holes that are sized and shaped to provide a fluid flow path for the gaseous fluid from the fermentation vessel to the exterior via the aperture of the lid body.

2. The fermentation device of claim 1, further comprising:
a lid cover coupled to the lid body, the lid being removably coupleable to the lid cover.

3. The fermentation device of claim 2 wherein the lid cover includes a plurality of tab elements and the lid includes a lid recess, the tab elements sized and shaped to be removably coupleably received by the lid recess.

4. The fermentation device of claim 1 wherein the lid body includes a chamber wall portion that protrudes outwardly from an interior surface of the lid body, the aperture extending through the chamber wall portion.

5. The fermentation device of claim 4 wherein the lid cap is spaced apart from the chamber wall portion to define a fluid passageway, the fluid passageway fluidly coupling the fermentation vessel to the chamber via the aperture.

6. The fermentation device of claim 1, further comprising:
a gasket disposed between the lid body and the fermentation vessel, the gasket sealingly coupling the fermentation vessel to the lid body.

7. The fermentation device of claim 6 wherein the gasket includes a gasket tab element.

8. The fermentation device of claim 1 wherein the fermentation lid assembly includes an opening which is sized and shaped to provide an expulsion flow path of the barrier fluid from the chamber to the exterior of the fermentation device.

9. The fermentation device of claim 8 wherein the opening is disposed in a spout element of a lid cover that is coupled to the lid body.

10. The fermentation device of claim 8 wherein the lid includes a lid tab element that protrudes through the opening.

11. A method for fermenting a food product disposed in a fermentation vessel having a fermentation fluid, the method comprising:
coupling the fermentation vessel to a fermentation lid assembly, the fermentation lid assembly including a lid and a lid body having a chamber;
removing the lid for exposing the chamber;
filling the chamber with barrier fluid to a desired level, the barrier fluid allowing flow of gaseous fluid from the fermentation vessel to an exterior environment while restricting flow of air from the exterior environment into the fermentation vessel; and
covering the chamber with the lid.

12. The method of claim 11, further comprising uncoupling the fermentation lid assembly from the fermentation vessel, the uncoupling providing access to the food product in the fermentation vessel.

13. The method of claim 11, further comprising removing excess barrier fluid when the barrier fluid exceeds the desired level.

14. The method of claim 11, further comprising:
prior to filling the chamber with barrier fluid, covering an aperture which provides a fluid pathway from the fermentation vessel to the chamber with a lid cap.

15. The method of claim 11 wherein coupling the fermentation vessel to the fermentation lid assembly includes sealingly engaging the fermentation vessel with the fermentation lid assembly via a gasket.
